(19) United States
(12) Patent Application Publication
(10) Pub. No.: US 2005/0216495 A1
(43) Pub. Date: Sep. 29, 2005

(54) Conversion method for multi-language multi-code databases

(76) Inventors: Sayling Wen, Taipei (TW); Zechary Chang, Taipei (TW); Mott Hou, Beijing (CN)

Correspondence Address: BIRCH STEWART KOLASCH & BIRCH, PO BOX 747, FALLS CHURCH, VA, 22040-0747, US

(21) Appl. No.: 10/806,126

(22) Filed: Mar. 23, 2004

(51) Int. Cl. G06F 17/00

(52) U.S. Cl. 707/101

(57) ABSTRACT

A conversion method for multi-language multi-code databases is disclosed. The method checks the original database file and confirms its type. The fields and the code type of the original database file are analyzed. The data in the fields are extracted. The data of each field are used to generate a new data file, which is converted to the local code for storage. It overcomes the problems and troubles of editing programs and using materials in different language and code types.

### BACKGROUND OF THE INVENTION

1. Field of Invention

The invention relates to a data conversion method and, in particular, to a conversion method for a multi-language multi-code database.

2. Related Art

Each country or area regulates a character code set for exchanging computer information. Examples include the US ASCII code, the Chinese GB2312-80 code and the Japanese JIS code. They play the role of unifying the information processing code in the country or area.

The character code sets are divided according to their length into single byte character sets (SBCS) and double byte character sets (DBCS). Earlier software (particularly the operating systems) tended to have local versions (LION) in order to solve the problem of using a particular character code set. To distinguish among them, the LANG and Codepage concepts have been introduced. However, since the scopes of different local character code sets have some overlaps, it is difficult in exchanging information. Moreover, the cost for maintaining each local version is higher. Therefore, some people start to extract the common natures of localizing software and make a uniform processing, reducing the amount of localizing tasks. This is the so-called internationalization (I18N). The language information is further gauged as locale information. The base character set becomes the Unicode that covers almost all characters.

The core characters of most of current programs with international characters are based upon the Unicode. When the software is running, it sets the local character code according to the Locale/LANG/Codepage settings at that moment. It needs to make conversions between Unicode and the local character set, or uses Unicode to make conversions between two different local character sets.

Theoretically speaking, the character conversion performed according to the character set settings should not have too many problems and difficulties. In fact, the code conversions produce many problems that have been bothering the programmers and users because Unicode and local character sets are not complete and the system or applications are not properly gauged.

The problems are particularly serious for those applications with sequel versions. For example, the display of traditional Chinese, simplified Chinese, Japanese, and Tai in such operating systems (OS) as Win98, Win2000, WinXP, and Linux is complicated. On the other hand, different databases use files of different types, such as FoxPro, Access, Outlook, Excel, and Text. Different platforms involve different codes. Therefore, editing them requires a huge amount of work and a lot of conversion processes. For example, the Access database in Windows cannot be used in Linux. Furthermore, the Japanese Access files cannot be used through non-Japanese Windows with a non-Unicode way.

### SUMMARY OF THE INVENTION

To solve the above-mentioned problems, the invention provides a conversion method for multi-language multi-code databases that can consistently process multi-language multi-code databases. This is useful for gauging the operations.

The invention provides a conversion method for multi-language multi-code databases for consistently processing multi-language multi-code databases. The method first checks an original database file and confirms its type. It then analyzes the field and code types of the original database file. The data in the original database file are extracted from the fields. The extracted data of each field are then used to generate a new database file that is to be stored using the local code.

Since the invention can define sufficient information in the newly generated data file, the same application can be employed to use different types of data. When distributing the data, a series of database files with the same filename. Consequently, different versions of the same document are generated. This solves the problems and difficulties in using data materials and programs because of different languages, codes, and platforms.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of the disclosed conversion method for multi-language multi-code databases.

### DETAILED DESCRIPTION OF THE INVENTION

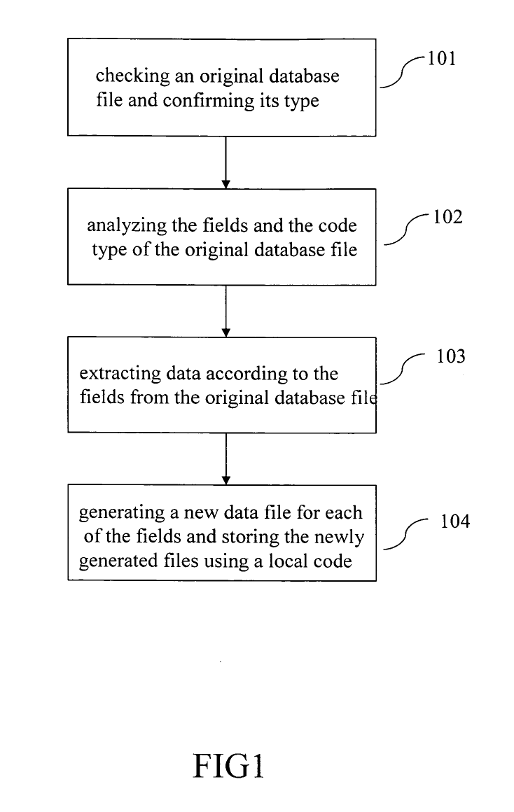

With reference to FIG. 1, the method first checks an original database file and confirms its type (step 101). From the database type, the method analyzes the fields and the code type of the original database file (step 102). Afterwards, the data are extracted according to the associated fields from the original database file (step 103). The extracted field data are used to generate a new database file and stored using the local code (step 104).

In step 101, the file type can be determined from the filename and suffix filename of the database file. When an application program needs to use these new files, the character set of the application program can directly read the new database file. The character set and the new data file have compatible local codes.

For example, some language learning programs supporting multiple languages may have their original materials in traditional Chinese, simplified Chinese, Japanese, Tai, Spanish, and English. However, the operating environment of the final product may be Win98, Win2000, WinXP, or Linux. When making such programs, one has to take into account the variety of the language of materials and its operating environment. To facilitate maintenance and editing, the invention enables the material editors to use its original file type. For example, FoxPro files use the local code, and Access files use Unicode. Since different types of files have different filenames and suffix filenames, it makes it easier to identify the file type. Note that the fields in different types of files have different characters.

Take an Access database file that does Chinese-English translation as an example. One can select and extract the two fields for English words and their translation to produce two new data files separately. Let's name the English field as “Ex” and the translation field as “Note.” At the same time, the method converts the Unicode to the BIG5 local code for Chinese and the Shift-JIS code for Japanese. If one is dealing with a FoxPro file, it can be operated directly because it is using the local code.

The structure of the newly generated data file is as follows

| Field | | Byte | Content |
|---|---|---|---|
| 1. | File | 4 | “IDX_” |
| 2. | Info | 4 | “INFO” |
| 3. | Len | 4 | obtained from 4-10 |
| 4. | Ver | 4 | “0001”, “0002” . . . |
| 5. | Offset Length | 1 | |
| 6. | Field Number | 1 | |
| 7. | Field Name Length (len) | 1 | |
| 8. | Field Name | len | |
| 9. | Field Type | 1 | |
| | | C - Character | |
| | | Y - Currency | |
| | | N - Numeric | |
| | | F - Float | |
| | | D - Date | |
| | | T - DateTime | |
| | | B - Double | |
| | | I - Integer | |
| | | L - Logical | |
| | | M - Memo | |
| | | G - General | |
| | | C - Character (binary) | |
| | | M - Memo (binary) | |
| | | P - Picture | |
| 10. | Keep Length Of All Fields | 1 | |
| // | Loop 7 to 10 | | |
| 11. | Code | 4 | “CODE” |
| 12. | Code Length Len | 4 | |
| 13. | Code Content | Len | |
| 14. | Data | 4 | “DATA” |
| 15. | Reserved | 4 | 0x0000 |
| 16. | Offset | obtained from 5 | |
| 17. | Field1 | obtained from 10 | |
| // | Loop 16 to 17 | | |

For application programs using these materials, a common program can be used to process newly generated data file. For the above example, the Chinese database is selected in a Chinese Windows environment to read the Note field, the Ex field can be used directly. In the Windows or Linux environment of other languages, correct fonts and character sets should be used instead.

Certain variations would be apparent to those skilled in the art, which variations are considered within the spirit and scope of the claimed invention.

1. A conversion method for multi-language multi-code databases to consistently process database documents in multiple language and code types, the method comprising the steps of:
checking an original database file and confirming its type;
analyzing the fields and the code type of the original database file;
extracting data according to the fields from the original database file; and
generating a new data file for each of the fields and storing the newly generated files using a local code.

2. The conversion method of claim 1, further comprising the step of the application program's using a correct character set to read the newly generated data file.

3. The conversion method of claim 1, wherein the file type is determined from its database filename in the step of checking an original database file and confirming its type.

4. The conversion method of claim 1, wherein the step of analyzing the fields of the original database file is performed according to the data file type.

5. The conversion method of claim 1, wherein the step of analyzing the code type of the original database file is performed according to the data file type.

6. The conversion method of claim 2, wherein the correct character set is compatible with the local code of the newly generated data files.
